(19) United States
(12) Patent Application Publication
(10) Pub. No.: US 2010/0332506 A1
(43) Pub. Date: Dec. 30, 2010

(54) MARKING SOUGHT AFTER CONTENT ITEMS ON NETWORK MEDIA DEVICES

(75) Inventors: Robert Glenn Deen, San Jose, CA (US); Ginger M. Myles, San Jose, CA (US)

Correspondence Address: CANTOR COLBURN LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/494,883

(22) Filed: Jun. 30, 2009

(51) Int. Cl. G06F 17/30; G06Q 30/00

(52) U.S. Cl. 707/759; 705/26; 707/E17.108; 707/769; 707/802; 707/803; 707/609; 707/812; 707/708

(57) ABSTRACT

According to embodiments of the invention, a system, method and computer program product for a computer program product for marking and acquiring sought after content are provided. Embodiments include a method comprising inserting a first desired content ID for a desired content item in a content directory for a first device in a network of media devices. The content directories of the devices in the network include content IDs of content present in the device, and also content IDs of content desired for the devices. Content directories of the other devices in the network are compared to determine if any of the other devices have a content directory containing the first desired content ID. For devices having the first desired content ID in its content directory, a determination is made of whether the desired content is present in the other device, and if the desired content is present in the other device, a copy of the desired content is transferred to the first device.

### BACKGROUND

The present invention relates to network media devices, and more specifically, to marking and acquiring sought after content items in network media devices.

A recent trend in home media devices, such as televisions, DVD players, digital video recorders (DVR), and MP3 music players, is the interconnection of such devices in the home via a local area network. Proposed or available networking solutions for home media devices use Ethernet or IEEE 1394 either over copper, fiber, wireless transports, or a combination to connect the devices.

Most solutions typically treat devices as distinct single instance devices. The use of the network may be limited to providing remote access to control the devices, and to carry streaming content from a decoding device (DVD player) to a rendering device (TV). Increasingly the content used in home media devices is held on the media devices as digital data encoded as files or groups of files and stored onto magnetic disk or flash media devices either directly connected to the media device or accessed by the device a network. Such content consists of a variety of media types including movies, television shows, music, and digital photographs.

### SUMMARY

According to one embodiment of the present invention, a method comprises: inserting a first desired content ID for a desired content item in a content directory for a first device in a network of media devices, the content directories of the devices in the network including content IDs of content present in the device, and also content IDs of content desired for the devices; comparing content directories of the other devices in the network to determine if any of the other devices have a content directory containing the first desired content ID; for devices having the first desired content ID in its content directory, determining if the desired content is present in the other device; and if the desired content is present in the other device, transferring a copy of the desired content to the first device.

According to another embodiment of the present invention, a method comprises: placing at least one content place holder in the content directory of a computer system that identifies particular content that the computer system is seeking, the computer system being interconnected to a plurality of computer systems; synchronizing the content in the directory of the computer system with the content in the plurality of computer systems; allowing the computer system to inform at least one of the plurality of computer systems during synchronizing of the presence of the particular content; and obtaining the particular content from at least one of the plurality of computer systems after the synchronizing.

According to a further embodiment of the present invention, a system comprises: a plurality of interconnected media players, each having access to items of content, the media players capable of exchanging the digital content with each other; a content list in each device containing a list of each item of content in the devices and a list of desired items of content for the devices; and a binary tree representation of each content list on each device.

According to another embodiment of the present invention, a computer program product for providing desired content in a network of media devices comprises: a computer usable medium having computer usable program code embodied therewith, the computer usable program code comprising: computer usable program code configured to: generate a binary tree for each device in a cluster of devices, the binary tree representing the locations of all copies of content residing in the device as well as desired content for the device; store in each device the binary tree for a plurality of other device in the cluster; use the binary trees for the plurality of other devices to determine the location of the desired content; and obtain the desired content from the determined location.

### BRIEF DESCRIPTION OF THE SEVERAL VIEWS OF THE DRAWINGS

FIG. 1 shows a block diagram of a content cluster of devices in accordance with an embodiment of the invention;

FIG. 2 shows a diagram of a binary tree in accordance with an embodiment of the invention;

FIG. 3 shows a flowchart of a process for obtaining desired content from a plurality of media devices in a network of such devices in accordance with an embodiment of the invention;

FIG. 4 shows a flowchart of a process for synchronizing content lists between devices in a network of devices in accordance with an embodiment of the invention; and

FIG. 5 shows a high level block diagram of an information processing system useful for implementing one embodiment of the present invention.

### DETAILED DESCRIPTION

Embodiments of the invention provide a system, method and computer readable medium for marking and acquiring sought after content items on network media devices. While much effort has gone into establishing the needed networking protocols and content protection systems to prevent unauthorized distribution of licensed content, relatively little innovation has occurred with respect to intelligent management of the content held and available from these networked media devices. It would be desirable to have intelligent management of the data files holding the content. Current state of the art is generally limited to making explicit copies of content from one device to another.

Digital Video Recorders do have the ability to create “Search Lists” which consist of search criteria for which the device will automatically record a copy. The user enters various search items either explicitly, or using matching patterns: Get all “Star Trek” episodes, or get any show with Star Trek in the title “* Star Trek*”. Such searches rely on the meta-data descriptions of television shows (title, actors, director, summary, date, genre, original broadcast/repeat) provided by the video delivery source (Cable or Satellite or Internet) to apply these search terms against. Examples of products in the market place with this ability are TiVo DVRs. In the case of TiVo this search is only applied to the single TiVo device on which it is created by the user. In addition, it is only used to direct the TiVo to record the show when broadcast over the video source (Cable or Satellite) that feeds the TiVo device. It does not have the ability to obtain a copy of the content data from other content holding devices on the network.

The ability to explicitly request content to be provisioned on device via synchronization of the device with a staging server is seen in Apple's Apple TV product. Here the Apple TV device contains a internal hard drive onto which content can be copied for later playback. Content is obtained from an iTunes application running on a PC in the same home, and connected via a network to the Apple TV device. Content to be copied is selected to either automatically any content available at the next synchronization operation, or by explicitly selecting content which is already present on the PC. However, Apple TV's solution does not allow for the device user to create selective requests to copy content items which do not yet exist on the PC. It is also limited to working with only one PC as a data source.

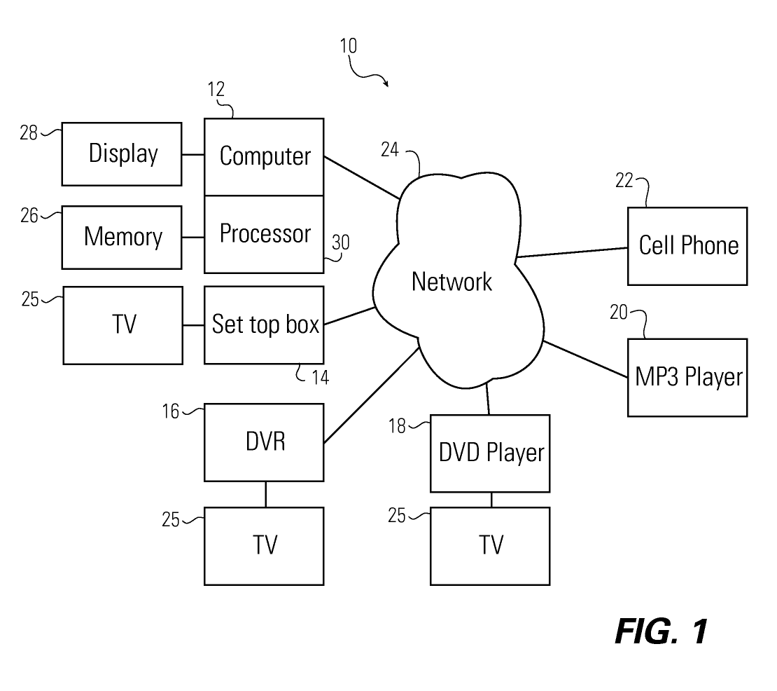

Referring now to FIG. 1 there is shown an exemplary content cluster 10 according to an embodiment of the invention. A plurality of devices, such as a computer, 12, a set top box 14, a digital video recorder (DVR) 16, a DVD player 18, an MP3 player 20 and a mobile telephone 22, are all connected to a network 24, such as a local area network (LAN) or a wide area network (WAN). In some embodiments, the network may connect the devices using Ethernet, or IEEE 1394, either over copper, fiber, wireless transports, or a combination of these methods. The set top box 14, DVR 16 and DVD player are each connected to one or more televisions 25. The computer 12 also includes an external memory unit 26, an external display unit 28 and a processor 30. It will be appreciated that the other devices 14-22 beside the computer 12 may all include internal or external memory units, display units and processors.

It is desirable for content stored in any of the devices 12-22 to be accessible to each of the devices. Information regarding the content in the various devices is stored in content lists, which consist of a unique identifier for each item of content, as well as a list of each known copy of the content item and the device which hold the copy.

Content items in the content cluster are identified by an identifier which is uniquely associated with the content item such that any two or more instances of the same content item (e.g. movie or song) regardless of what device they are stored on, will have the same content identifier.

One example of a content cluster 10 in which embodiments of the invention can be applied is IBM's Advanced Secure Content Cluster Technology (ASCCT), which includes a Content Directory which features a list of content items held on a device, along with the list of replicas of content items present on other devices in the cluster. ASCCT provides a fast synchronization protocol by which devices in the cluster publish a hash tree representing the content items held on the device.

The hash tree representing the content held on a device is constructed by taking the Content ID of each held content item and grouping it with other content items which have the same first two characters. Content IDs are 16 byte values deterministically derived such that two identical content items, such as the same move, will have the same value. This is accomplished by using the Content URN for the content item as the input to an AES-128 hash function which transforms the Content Universal Resource Name (URN) into a statistically distinct 16 byte value. The Content URN is assigned to a content item by either the creator of the content or the distributor. This value is used to uniquely identify content items.

Each device in the cluster exchanges their respective content state trees with one another. By comparing the current tree from a device with the previous tree received, it is easy to detect which groups of content have additions or deletions had made to them. A second comparison, by the receiving device, allows the receiving device to determine the leaves of the tree that it must retrieve from the other device so it can update its local list of content. This comparison of trees can be done using simple equality comparison operators. For example, if you XOR the values and the result is all 0s, then there was no changes in the branch. The Content Directory in ASCCT, as currently described, only manages content items on the local device and the list of content replicas on other devices.

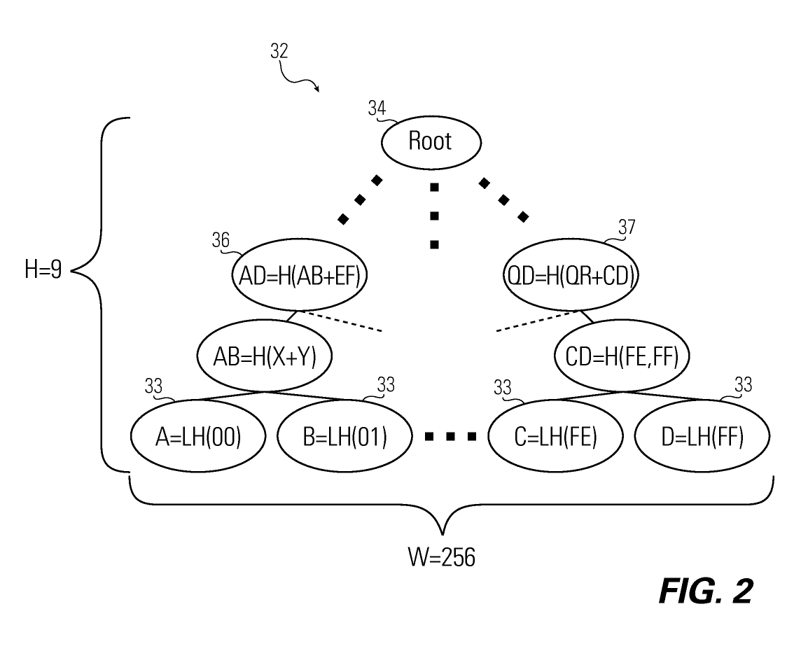

FIG. 2 shows an exemplary content state tree, which is a binary tree 32, according to embodiments of the invention. In this example, AES 128 is used as a hash to produce a 128 bit/16 byte hash value, using the first two characters of the content ID as the grouping criteria. This would produce the hash tree 32 for the device content list. This example tree 32 has 256 leafs 33 since the example content ID is 16 byte value expressed in hexadecimal with the following character range [0 . . . 9,A-F]. Using the first two bytes of such a content ID results in a possible 256 groups with first two bytes ranging in value from 00 through FF. In turn this produces a tree of 9 levels, and 511 nodes each holding a 16 byte hash value. Thus the entire tree is 8176 bytes in size.

Each node of the binary tree is same size, because the hash function always returns a fixed number of bits. As a result, the hash tree can be expressed as a contiguous series of bytes composed of the values of the nodes appended together following a fixed path through the tree.

An example of a fixed path through the tree is a breadth first path starting from the root node 34, followed by the left most node 36 at the next level, and through each node at that next level in turn until the right most node 37 is reached. This process is repeated level by level until the process reaches the last level of leafs, which are traversed it the same way. This system can use any path traversal method so long as it is consistently followed by all devices.

Applying the above described breadth-first approach for traversal to the above example would produce the following 8176 byte string express of the example tree.
[node 1]_{16 bytes}[node 2]_{16 bytes} . . . [node 511]_{16 bytes}=String of 8176 bytes in the range [0 . . . 9,A-F]

The value of the leaf node for a particular group will change if the group of content entries in it changes. Such a change would occur if new items were added to, or removed from the group, or if any of the content entries in the group changed. Thus, any change to the content list, or any change to an element in the content list, is reflected by a change in the hash value of the group to which the change applied. In turn, since each higher level is computed based upon the lower level, changes at the leaf nodes are reflected upwards in the tree. Finally, the root node 34 value will change. Changes of a node at a given level reflect that one or more changes have occurred in the nodes below it.

Thus it is possible to see if any changes to the entire content list have occurred by examining simply the root node 34. If it has a new value, then one or more changes have occurred in the list. The location of the changes can be deduced by comparatively examining the tree 32 moving downward from the root node 34. A change in a node at a given level indicates a change in the nodes below it. No change in a node reflects that no changes have occurred in any of nodes in the branch below it. This forms a highly efficient mechanism to first detect if the content list has changed, and to locate where the changes have occurred. By storing the most recently stored tree of a given content list, and comparing it to the latest hash tree of the same list, it is possible to efficiently determine if the list has changed, and if so, to identify those groups which have changes in them. One advantage of such a comparison is that on average it allows the location of changed leaf node values to be determined faster than a sequential search of all the leaf nodes for changes, so long as not all the leaf nodes have changed. Further details of the use of the binary tree 32 in content clusters may be found in copending U.S. patent application Ser. No. ______, entitled “Synchronized Content Directories on Cluster Devices”, which is owned by the same assignee as the present invention and which is incorporated herein by reference.

In accordance with embodiments of the invention, a device is allowed to insert a Content ID for content that it does not locally posses in its Content Directory. The effect of this will be to allow a device to detect when other devices in the cluster posses content with the matching Content ID. To make this practical, the device requires a method to obtain Content IDs and a method to make sure it does not misrepresent to other devices that it is in possession of that content.

To compute the Content ID of the desired content, the device will have to obtain the Content URN for the content. This could be done via a variety of methods, such as querying an established database of Content URN entries, or it could be obtained from other Content items' meta-data. The meta-data could include Content URN's for similar content such as related shows, special editions of the content, or versions of the content encoded with different encodings such as resolutions or quality.

The disambiguation of Content IDs, which are place holders for sought content, versus actual content instances can be done by examining the replica entries for a content item. Since a device that holds content also lists its local copy in its list of known replicas, it is simply a matter of checking to see if the device is listed as holding a replica instance. If there is no replica instance, the Content ID is a place holder for desired content.

The introduction of content place holders enables a variety of new operations by the device to intelligently work with content items. In various embodiments of the invention, these operations may include: (1) Automated provisioning of content on mobile devices; (2) Automated back up of content items; (3) Automated warning of inappropriate or banned material on the network; (4) Automated purchasing of content from online content providers; and (5) Creation of aggregated lists of sought content by all devices or users of the network. These five operations are described in more detail below.

Automated provisioning of content on mobile devices may be accomplished by placing a content place holder into the mobile device's Content Directory. When the desired content was discovered to be available on the network, the device could then be triggered to obtain a copy of the content from one of the devices holding a replica of the content.

Automated back up of content items may be accomplished by creating a backup device that contained the entries for content where the cluster wanted to ensure a backup or duplicate copy would automatically be made. Using the approach similar to that used to provision mobile devices; the backup device would be triggered to perform a backup operation on content when it was detected as being available on the network.

Automated warning of inappropriate or banned material on the network may be accomplished by placing the content items into the monitoring device's Content Directory. When the matching content is discovered; an action such as requesting the deletion of the content by the possessing device or publishing an alert to a user or log would be triggered.

Automated purchasing of content from online content providers may be accomplished by the online content provider having a device (virtual or real) that would connect to the network and synchronize with the devices. The device may be able to detect the presence of a content place holder and then provide the requested content to the device. This operation may include automated billing via a pre-arranged account.

Creation of aggregated lists of sought after content by all devices or users of the network could be accomplished by synchronizing with the devices available on the network and building a new list consisting of the sought content that devices seek. This would allow higher level operations, such as ranking of requested material by request instances, which in turn could be used to determine priority for delivery to the network. Other higher level operations may include the application of pricing algorithms, or processes to determine optimal delivery of desired content.

When done across many different home networks, this aggregation of desired content using the teachings of the invention, could be used to build lists of desired content, which in turn could be used by content providers to make informed decisions of which content they should provide.

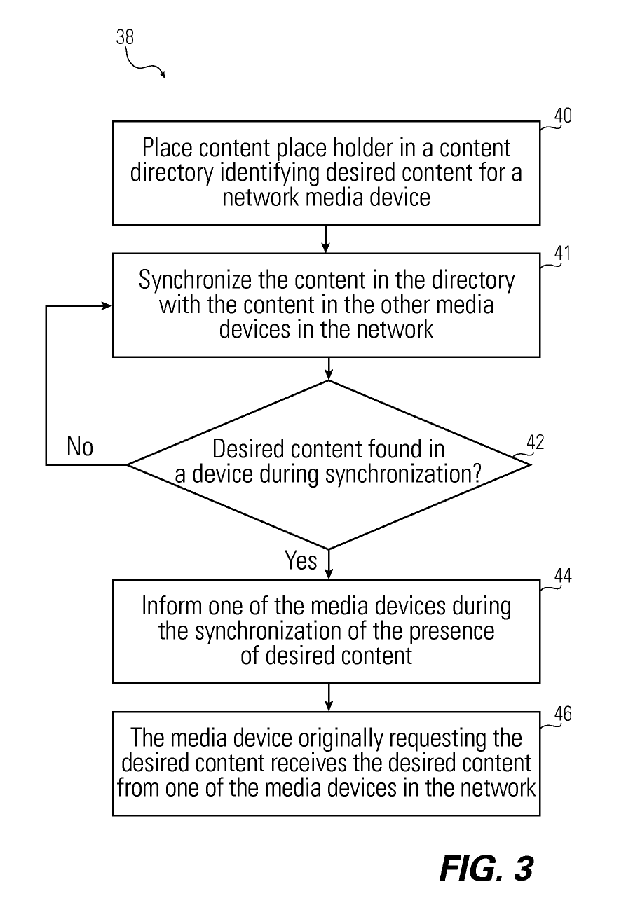

FIG. 3 shows a flowchart of a process for obtaining desired content in accordance with an embodiment of the invention. At block 40, a content placeholder is placed in a content directory identifying the desired content for a network device. The content in the directory is synchronized with the content in the other media devices in the network, at block 41. A determination is made of whether the desired content is found during synchronization, at decision block 42. If it is found, one of the media devices is informed during the synchronization of the presence of desired content at block 44. At block 46, the media device originally requesting the desired content receives the desired content from one of the media devices in the network. If the desired content is not found in block 42, the process returns to block 41 to continue synchronization until synchronization is complete.

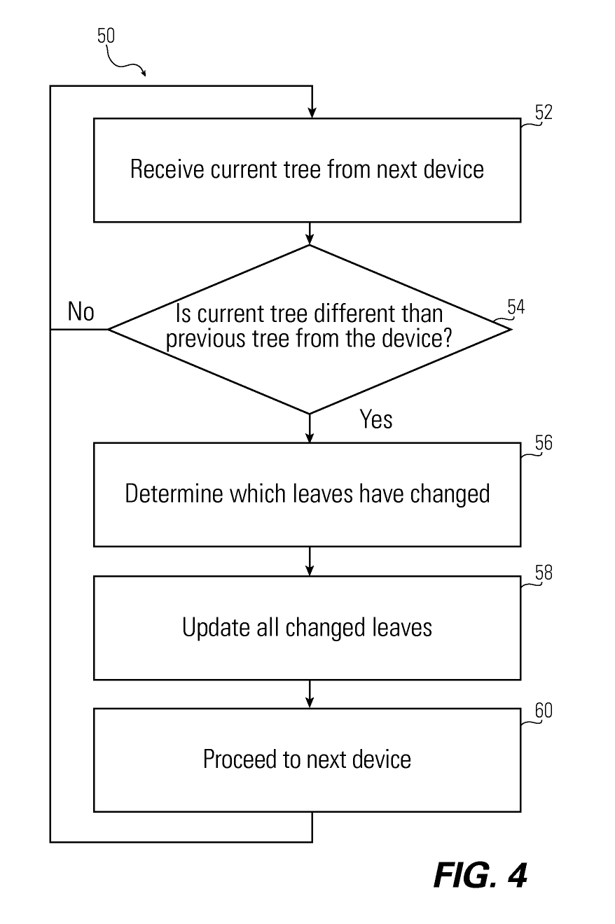

FIG. 4 shows a flowchart of a process 50 for synchronizing content lists between devices in a cluster of devices. At block 52 the current binary tree is received from a device. The process then determines if the current tree is different from the previous tree received from the device, in decision diamond 54. If it is different, at block 56, the process determines which leaves have changed. If the current tree is not different the process returns to block 52 to process the next device. All the changed leaves are then updated at block 58. At block 60, the process 50 moves back to block 52 to process the next device until all the devices in the cluster have been processed.

As can be seen from the above disclosure, embodiments of the invention provide a system by which a sought after content items on content network media devices cluster may be marked and acquired.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Furthermore, the present invention may take the form of a computer program product embodied in any tangible medium of expression having computer usable program code embodied in the medium. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wire line, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

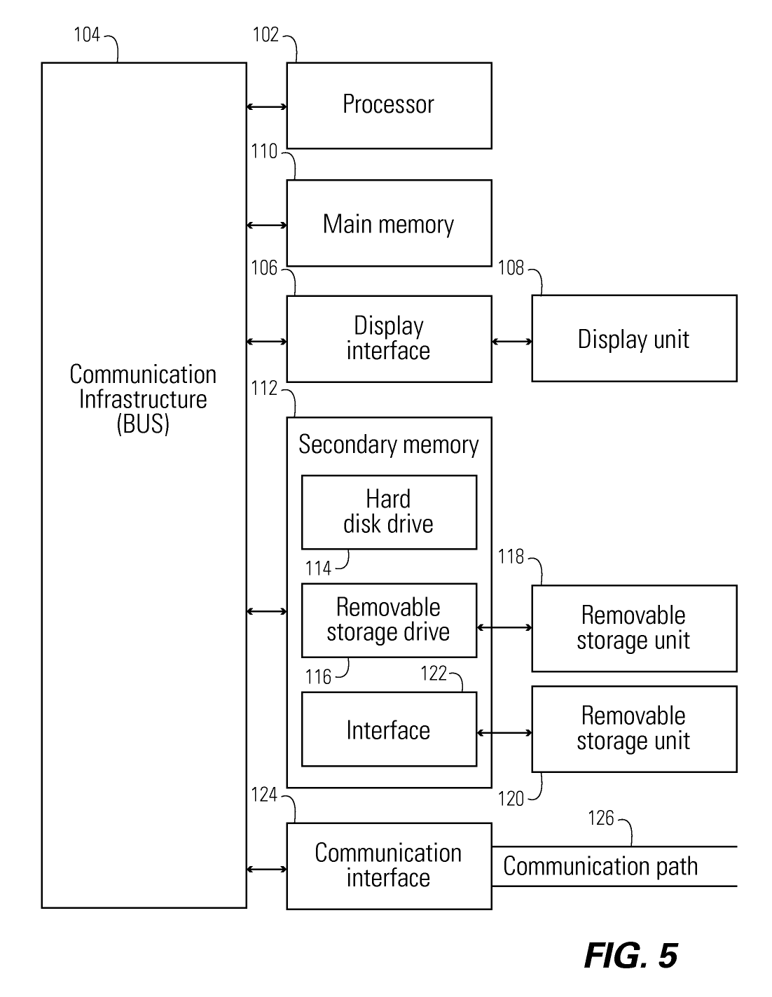

FIG. 5 is a high level block diagram showing an information processing system useful for implementing one embodiment of the present invention. The computer system includes one or more processors, such as processor 102. The processor 102 is connected to a communication infrastructure 104 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 106 that forwards graphics, text, and other data from the communication infrastructure 104 (or from a frame buffer not shown) for display on a display unit 108. The computer system also includes a main memory 110, preferably random access memory (RAM), and may also include a secondary memory 112. The secondary memory 112 may include, for example, a hard disk drive 114 and/or a removable storage drive 116, representing, for example, a floppy disk drive, a magnetic tape drive, or an optical disk drive. The removable storage drive 116 reads from and/or writes to a removable storage unit 118 in a manner well known to those having ordinary skill in the art. Removable storage unit 118 represents, for example, a floppy disk, a compact disc, a magnetic tape, or an optical disk, etc. which is read by and written to by removable storage drive 116. As will be appreciated, the removable storage unit 118 includes a computer readable medium having stored therein computer software and/or data.

In alternative embodiments, the secondary memory 112 may include other similar means for allowing computer programs or other instructions to be loaded into the computer system. Such means may include, for example, a removable storage unit 120 and an interface 122. Examples of such means may include a program cartridge and cartridge interface (such as that found in video game devices), a removable memory chip (such as an EPROM, or PROM) and associated socket, and other removable storage units 120 and interfaces 122 which allow software and data to be transferred from the removable storage unit 120 to the computer system.

The computer system may also include a communications interface 124. Communications interface 124 allows software and data to be transferred between the computer system and external devices. Examples of communications interface 124 may include a modem, a network interface (such as an Ethernet card), a communications port, or a PCMCIA slot and card, etc. Software and data transferred via communications interface 124 are in the form of signals which may be, for example, electronic, electromagnetic, optical, or other signals capable of being received by communications interface 124. These signals are provided to communications interface 124 via a communications path (i.e., channel) 126. This communications path 126 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 110 and secondary memory 112, removable storage drive 116, and a hard disk installed in hard disk drive 114.

Computer programs (also called computer control logic) are stored in main memory 110 and/or secondary memory 112. Computer programs may also be received via communications interface 124. Such computer programs, when executed, enable the computer system to perform the features of the present invention as discussed herein. In particular, the computer programs, when executed, enable the processor 102 to perform the features of the computer system. Accordingly, such computer programs represent controllers of the computer system.

From the above description, it can be seen that the present invention provides a system, computer program product, and method for implementing the embodiments of the invention. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
inserting a first desired content ID for a desired content item in a content directory for a first device in a network of media devices, the content directories of the devices in said network including content IDs of content present in said device, and also content IDs of content desired for said devices;
comparing content directories of said other devices in said network to determine if any of said other devices have a content directory containing said first desired content ID;
for devices having said first desired content ID in its content directory, determining if said desired content is present in said other device; and
if said desired content is present in said other device, transferring a copy of said desired content to said first device.

2. A method according to claim 1 wherein said determining if said first desired content is present in said other device comprises:
identifying desired content by determining if a replica of content having said first desired content ID is present in said other device's content directories, the absence of a replica indicating that the content is desired content.

3. A method according to claim 1 further comprising creating a binary tree of each of said items of digital content in said devices in said network, each item of content being represented by a leaf node in said tree, wherein a change in any item of content in any of said devices results in a change in said binary tree.

4. A method according to claim 3 wherein said comparing further comprises:
periodically updating said binary tree in each device by exchanging said binary tree for each device with every other device;
determine if there are any changes to a binary tree by comparing a root node of a current tree with a root node of a previously stored root node; and
if the current root node is different, then updating the locally stored binary tree for said deice by replacing only those nodes below said root node that have changed.

5. A method according to claim 4 wherein said creating a binary tree further comprises:
partitioning nodes in said binary tree according content IDs using a predetermined partitioning criteria; and
grouping said nodes by content ID based on said partitioning.

6. A method comprising:
placing at least one content place holder in the content directory of a computer system that identifies particular content that said computer system is seeking, said computer system being interconnected to a plurality of computer systems;
synchronizing the content in said directory of said computer system with the content in said plurality of computer systems;
allowing said computer system to inform at least one of said plurality of computer systems during synchronizing of the presence of said particular content; and
obtaining said particular content from at least one of said plurality of computer systems after said synchronizing.

7. A method according to claim 6 wherein said synchronizing comprises:
identifying each item of content in said directory with a unique content URN; and
listing a set of computer systems among said plurality of computer systems that comprise an instance of said particular content said system is seeking in said directory.

8. A method according to claim 7 wherein said placing comprises identifying said particular content with a particular content URN.

9. A method according to claim 6 further comprising representing said content directory as a binary tree.

10. A method according to claim 6 wherein said particular content is content that is desired to be backed up.

11. A method according to claim 6 wherein said particular content is content that is not allowed on said computer system.

12. A method according to claim 6 wherein said particular content is content that is to be purchased.

13. A method according to claim 12 further comprising automatically placing an order to purchase said particular content prior to said obtaining said particular content.

14. A method according to claim 6 further comprising building an aggregated list of sought content throughout said network.

15. A method according to claim 14 further comprising ranking a plurality of particular content based on the number of instances of said particular content being sought in said aggregated list.

16. A method according to claim 14 using said aggregated list to determine which content to supply to said network.

17. A system comprising:
a plurality of interconnected media players, each having access to items of content, said media players capable of exchanging said digital content with each other;
a content list in each device containing a list of each item of content in said devices and a list of desired items of content for said devices; and
a binary tree representation of each content list on each device.

18. A system according to claim 17 wherein said binary tree representation is constructed by placing a hash representation of each of said items of digital content on leaf nodes of said binary tree and calculating higher nodes on said binary tree as hash values of lower nodes until a root node is calculated, wherein a change in any item of content in any of said devices results in a change in said root node.

19. A computer program product for providing desired items of content in a network of media devices, said computer program product comprising:
a computer usable medium having computer usable program code embodied therewith, said computer usable program code comprising:
computer usable program code configured to:
generate a binary tree for each device in a cluster of devices, said binary tree representing the locations of all copies of content residing in said device as well as desired content for said device;
store in each device said binary tree for a plurality of other device in said cluster;
use said binary trees for said plurality of other devices to determine the location of said desired content; and
obtain said desired content from said determined location.

20. A computer program product according to claim 19 wherein said using said binary tree comprises identifying desired content by determining if a replica of content having said first desired content ID is present in said other device's content directories, the absence of a replica indicating that the content is desired content.
